(19) United States
(12) Patent Application Publication
(10) Pub. No.: US 2025/0304458 A1
(43) Pub. Date: Oct. 2, 2025

(54) INTEGRATED SYSTEM FOR CH4 AND NH3 SYNTHESIS

(71) Applicant: CONOCOPHILLIPS COMPANY, Houston, TX (US)

(72) Inventors: Adam STONE, Houston, TX (US); Ramesh SHARMA, Houston, TX (US)

(73) Assignee: CONOCOPHILLIPS COMPANY, Houston, TX (US)

(21) Appl. No.: 19/082,860

(22) Filed: Mar. 18, 2025

Related U.S. Application Data
(60) Provisional application No. 63/569,873, filed on Mar. 26, 2024.

(51) Int. Cl. C01C 1/04; B01D 53/26; B01J 19/00; B01J 19/24; C02F 11/04

(52) U.S. Cl. CPC C01C 1/04; B01D 53/265; B01J 19/0013; B01J 19/2445; C02F 11/04; B01D 2257/80; B01J 2219/00103

(57) ABSTRACT

The disclosure presents an integrated system consisting of a wastewater production unit, e-methane reactor, an electrolyzer for producing hydrogen, a cryogenic separation unit and an ammonia production unit, where e-methane is produced by reaction of carbon dioxide obtained from direct air capture/biogenic CO₂/captured industrial CO₂ emissions/oxidized solid carbon, and from CO₂ separated from biogas obtained from wastewater treatment, and hydrogen gas from electrolysis of water. The hydrogen gas is also reacted with nitrogen obtained from the cryogenic unit for the synthesis of ammonia, where heat from ammonia synthesis is transferred to e-methane reactor for energy efficiency. By integrating these units and reactors, the disclosure provides a system for efficient use of energy and by-products.

### PRIOR RELATED APPLICATIONS

This application claims priority to U.S. Ser. No. 63/569,873, filed Mar. 26, 2024 and incorporated by reference in its entirety for all purposes.

### FEDERALLY SPONSORED RESEARCH STATEMENT

Not applicable.

### FIELD OF THE DISCLOSURE

The disclosure generally relates to an integrated system for the synthesis of methane and ammonia, treatment of wastewater, and generation of hydrogen and e-fuel, whereby product and energy from one reactor is used in another reactor in a closed loop. This integrated system increases overall efficiency of production of these gases, and thus increases profitability and helps reduce carbon footprint.

### BACKGROUND OF THE DISCLOSURE

The term “net zero” applies to a situation where global greenhouse gas emissions from human activity are balanced by emission reductions or sequestration. At net zero, carbon dioxide emissions are still generated, but an equal amount of carbon dioxide is removed from the atmosphere as released, resulting in no overall increase in emissions. With the increasing importance and a pressing need for a net zero carbon economy, multiple strategies are being adopted to cut greenhouse gas emissions and reduce/counterbalance the release of carbon dioxide.

Some of these efforts include reduced dependance on fossil fuels, increasing use of alternate energy sources, improving energy efficiency, conservation of energy, carbon capture and storage, climate smart agriculture, and combinations of all these various methods. However, the transition to more sustainable energy production is not simply accomplished by abandoning existing technologies—a balance between current technologies and new environmentally supportable technologies are needed for economic and technological sustainability.

Although the most obvious means to achieving net zero is to reduce burning of fossil fuels and replace with green alternatives, these efforts take time and resources and interim measures of shifting carbon content in the environment are also being pursued. One of the ways of reducing natural gas usage is to replace natural gas with synthetic alternatives. Synthetic alternatives, called ‘electrofuels’ or ‘e-fuels’, are made from two raw materials-hydrogen gas produced by electrolysis of water, and carbon dioxide (CO₂) captured from air or flue gas.

The idea of using synthetic e-fuels as an alternative to fossil fuels such as natural gas to achieve a carbon neutral economy may sound counterintuitive, but these synthetic e-fuels are produced using captured CO₂—typically from ethanol plants—or by direct air capture (DAC). Thus, the production of e-fuel using captured CO₂ provides a way to produce energy without contributing to the net carbon output.

E-methane is one of the most commonly produced e-fuels. In nature, methane is produced by bacterial anaerobic digestion of plant and animal waste. Chemically, several pathways for producing methane (CH₄) are known in the literature. Methane is frequently produced by the reaction of hydrogen gas with carbon dioxide gas in a reaction called Sabatier reaction, shown in Eq. 1.

$$4 {H}_{2} + {CO}_{2} \to {CH}_{4} + 2 {H}_{2} O \qquad Eq . 1 ( Sabatier reaction )$$

This reaction takes place at high temperatures of about 300-400° C. (˜570-750° F.) and pressures up to 30 atm (˜440 psi) in the presence of a nickel-based catalyst. For e-methane production, the hydrogen gas used in the Sabatier reaction is obtained from electrolysis of water and the carbon dioxide is obtained from carbon captured from burning of natural gas or preferably by direct capture from the air or from a biological source such as biogas.

E-methane can also be formed by hydromethanation by reacting steam with a carbon source, like carbon black, graphite, or other carbon feedstock, catalyzed by a metal catalyst. See Eq. 2 below. Hydrogasification-reaction of carbon source with hydrogen gas to form methane, is another reaction for the formation of methane, shown in Eq. 3.

$$2 C + 2 {H}_{2} O \to {CH}_{4} + {CO}_{2} \qquad Eq . 2 ( Hydromethanation )$$

$$2 {H}_{2} + C \to {CH}_{4} \qquad Eq . 3 ( Hydrogasification )$$

Pyrolysis or plasmolysis (the dissociation of ammonia, methane, hydrocarbons and other molecules using plasma) can be used to produce carbon black and hydrogen from methane, ethane, and other hydrocarbons. Carbon black is stable and can be shipped worldwide to other locations to be used as a soil enhancer, asphalt, built into concrete or steel, refine the carbon black into graphite, nanotubes, batteries, ink dye and other carbon solids.

Additionally, the carbon black may be used to create a carbon cycle, as described herein whereby carbon is sequestered by pyrolysis or plasmolysis to generate carbon black and hydrazine which can then be transported to a methane generation plant. The methane is then generated and used in the cycles described herein.

Another potential source of carbon dioxide for the production of e-fuel is biogas. Biogas is a renewable fuel produced by the anaerobic breakdown of organic waste from plant and animal products (including biomass, manure, and sewage) by bacteria in an oxygen-free environment. Biogas contains approximately 50-70% methane, 30-40% carbon dioxide, and trace amounts of other gases (all by volume), including nitrogen. In a wastewater management facility, organic matter from waste is treated to produce clean water and organic sludge. The sludge is further digested by anaerobic bacteria to produce biogas. The methane from the biogas can be separated and stored as CNG or LNG, and the CO₂ from the biogas (biogenic CO₂) vented or may also be used in synthesis of e-fuels by reacting the biogenic CO₂ with hydrogen gas.

Although hydrogen is the most abundant chemical substance on earth, most of it is found bonded as part of another compound, such as water (H₂O), methane (CH₄), ammonia (NH₃), etc. Pure hydrogen gas is currently derived from natural gas using steam reforming of methane. In steam reforming process, natural gas is first reacted with high temperature steam to produce synthesis gas. Synthesis gas is a mixture of hydrogen, carbon monoxide, and a small amount of carbon dioxide. The carbon monoxide in the synthesis gas is further reacted with high temperature steam to produce hydrogen and carbon dioxide. The carbon dioxide produced during this reaction is either released to the atmosphere or captured and stored for further use or sequestration.

Another method for producing hydrogen gas is from electrolysis of water—that is splitting water into hydrogen and oxygen using electricity, shown in Eq. 4. If the electricity is produced by renewable sources, such as hydroelectric, solar, or wind or even no carbon-output nuclear energy, the resulting process would be free of CO₂ emissions, and the resulting hydrogen called “clean” hydrogen.

$$2 {H}_{2} O \to 2 {H}_{2} + {O}_{2} \qquad Eq . 4$$

Hydrogen gas is also used in the production of ammonia (NH₃). Ammonia is an important industrial product that is either directly or indirectly used in the synthesis of many pharmaceutical and commercial cleaning products. It is a hazardous and caustic chemical, and thus the production, handling and storage of ammonia is carried out with strict safety measures. Ammonia is synthesized industrially through the Haber-Bosch process which involves reaction of nitrogen gas with hydrogen over a bed of catalyst-typically silver or iron based. The Haber-Bosch process is carried out at high pressures of about 200-400 atm (˜2940 to 5900 psi) and at temperatures ranging from 400-650° C. (750-1200° F.). The reaction of nitrogen and hydrogen to form ammonia, shown in Eq. 5, is highly exothermic.

$${N}_{2} + 3 {H}_{2} \to 2 {NH}_{3} + Heat \qquad Eq . 5$$

Nitrogen gas for the production of ammonia is primarily obtained by separation of gases from the atmosphere. This is achieved by cryogenic air separation units (CASUs). CASUs separate out and liquefy atmospheric gases into its primary components. Liquid nitrogen and oxygen along with other inert gases like argon are obtained from a CASU. The process of separation involves cooling air to liquefy all gases and then selectively distilling and separating each of the components. Generally, a CASU is a stand-alone unit, and each separated gas is packaged and stored in cylinders and transported for use as required. Oxygen is typically sent for purification and use in hospitals, for fuel in aerospace industry, for steelmaking, etc. The nitrogen gas is sent to be used in ammonia plants or for use as an inert gas in sensitive metal-based chemical reactions. The CASU or any other cryogenic separator can also be used to separate biogas.

As discussed, biogas contains high amounts of carbon dioxide that is usually vented or disposed of; e-fuel synthesis requires large amount of heat and also produces water that is generally disposed of; hydrogen gas production by electrolysis produces hydrogen and oxygen, and typically the oxygen is vented off if the production plant does not have cooling capabilities to hold liquid oxygen; and production of ammonia using Haber-Bosch process is extremely exothermic. Each of these reactions and processes thus separately discard gases, water, and/or energy. In order to improve efficiency and to decrease costs, two or more or each of the aforementioned reactions and processes can be integrated such that the waste product from one reactor can be starting product for the other, and/or energy released from one reaction can be harnessed and used as energy for another reactor.

Thus, what is needed in the art are systems that combine the generation and synthesis of gases such as biogas, e-fuel, ammonia, hydrogen, and cryogenic oxygen to provide an integrated system with minimum infrastructural and storage cost, smaller carbon footprint, minimum to zero waste of material and energy, environmental stability and high efficiency. This invention addresses one or more of these needs.

### SUMMARY OF THE DISCLOSURE

Described herein are methods and systems for integrating the synthesis and generation of e-fuel or biomethane and ammonia, where by-product and energy from one reactor is used for the next reaction in an integrated loop, thereby minimizing waste, capturing and reusing heat, and re-using gases. The described system integrates a wastewater treatment plant with e-fuel production and a water electrolyzer that are integrated with a cryogenic air separation unit and ammonia production plant.

In general, the integrated system consists of at least the following seven units, any of which can be standalone or combined with another one or more units as appropriate:
1) a wastewater treatment plant;
2) an anaerobic digester unit;
3) a biogas separation unit;
4) an electrolyzer or other water splitting unit;
5) an e-fuel reactor;
6) a cryogenic air separation unit (CASU); and
7) an ammonia production plant.

These units are interconnected as follows:
i) The wastewater treatment plant treats wastewater to produce clean water and organic sludge. The sludge from the wastewater treatment plant is fluidly transferred to the anaerobic digester unit.
ii) The digestion of the sludge produces biogas (mostly CO₂ and CH₄) and water.
iii) The biogases are separated into CH₄ and CO₂ at the separation unit, or possibly also the cryogenic air separation unit or CASU.
iv) The CASU separates out atmospheric gases into liquid nitrogen, liquid oxygen, and water.
v) Water from one or more of the wastewater treatment plant, anaerobic digestion unit, separation unit and/or CASU or anywhere within the system are fluidly coupled to the electrolyzer.
v) The electrolyzer (or other water splitting unit) produces hydrogen gas and oxygen gas by electrolysis or other splitting of water.
vi) Oxygen gas produced from the electrolyzer is fluidly coupled to the wastewater treatment plant to support microbial growth. It may also be stored in oxygen cylinders and sold.
vii) CO₂ from one or more of the biogas separation unit, CASU, direct air capture or other sources, and hydrogen gas from the electrolyzer are mixed in the e-fuel reactor for producing an e-fuel.
viii) The e-fuel reactor is thermally coupled to the liquid nitrogen line from the CASU such that the heat produced from the production of e-fuel converts the liquid nitrogen to gaseous nitrogen. Thus, the liquid nitrogen cools the e-methane stream on each interstage of the 4+ stages/passes of heating and cooling (see FIG. 3), which incrementally increases the conversion of H₂ and CO₂ to CH₄ and H₂O, and at the same time is converted to a gas for use in the ammonia production plant.
ix) Hydrogen gas from the electrolyzer, and gaseous nitrogen produced by warming liquid nitrogen from the CASU, are fluidly coupled to the ammonia production plant to produce ammonia.
x) The ammonia production plant and the e-fuel reactor are thermally connected such that heat from the reaction of N₂ (gas) and H₂ (gas) to produce ammonia drives the e-fuel reactor by driving the heating of each subsequent heating stage/pass to increase the conversion of H₂ and CO₂ to CH₄ and H₂O.

Any one or more of these above functions may be integrated together into combined units. For example, the anaerobic digestion unit may be combined with the biogas separation unit to form a combined digester and separation unit, and typically filtration will be included in one or more water treatment units.

Thus, in this kind of integrated system, waste of gases and energy is minimized by the re-use of surplus product and by-products. This significantly improves efficiency of producing commercial products like e-fuel and ammonia by incorporating gas lines and heat exchangers.

In preferred embodiments, all the units in the integrated system will be at the same location or nearby. However, space management and industrial set-up of plants for production of ammonia and e-fuel may require that regular gases or water be trapped in gas cylinders and storage units, and stored gases be transported to another production facility. The efficiency of a single-location system is better, however, and is thus preferred.

The invention includes and one or more of the following embodiments, in any combination(s) thereof:

An integrated system for producing e-fuel and ammonia, said system comprising components a)-g) as follows:
a) a wastewater treatment plant;
b) an anaerobic digestion unit;
c) a biogas separation unit;
d) a water splitting unit;
e) an e-fuel reactor;
f) a cryogenic separation unit; and
g) an ammonia production plant;
wherein said components a)-g) are interconnected as follows:
   i) said wastewater treatment plant producing a first water and a sludge;
   ii) said sludge fluidly coupled to said anaerobic digestion unit for producing a biogas and a second water;
   iii) said biogas fluidly coupled to said biogas separation unit for producing methane and carbon dioxide;
   iv) said cryogenic separation unit separating atmospheric gases into a liquid nitrogen, a liquid oxygen, and a third water;
   v) said liquid nitrogen fluidly coupled via a line 1 to said ammonia production plant;
   vi) at least one of said first, second and/or third water(s) fluidly coupled to said water splitting unit;
   vii) said water splitting unit producing a hydrogen gas (H₂) and an oxygen gas (O₂);
   viii) said O₂ from said water splitting unit fluidly coupled to said wastewater treatment plant;
   ix) a first portion of said H₂ from said water splitting unit fluidly coupled to said e-fuel reactor plus carbon dioxide (CO₂) fluidly coupled to said e-fuel reactor, said e-fuel reactor producing an e-fuel from said hydrogen gas and said carbon dioxide;
   x) said e-fuel reactor thermally coupled to said line 1 such that heat from said e-fuel reactor converts said liquid nitrogen to gaseous nitrogen;
   xi) a second portion of said H₂ fluidly coupled to said ammonia production plant for producing ammonia from said H₂ and said gaseous nitrogen from line 1;
   xii) said ammonia production plant thermally coupled to said e-fuel reactor such that heat from said ammonia production plant drives said e-fuel reactor; and
   xiii) said e-fuel fluidly coupled to a storage and/or distribution system.

An integrated system for producing e-fuel and ammonia, said system comprising components a)-g) as follows:
a) a wastewater treatment plant;
b) an anaerobic digestion unit;
c) a biogas separation unit;
d) an electrolyzer;
e) an e-fuel reactor;
f) a cryogenic separation unit; and
g) an ammonia production plant;
wherein said components a)-g) are interconnected as follows:
   i) said wastewater treatment plant producing a first water and a sludge;
   ii) said sludge fluidly coupled to said anaerobic digestion unit for producing a biogas and a second water;
   iii) said biogas fluidly coupled to said biogas separation unit for separating e-fuel and carbon dioxide from said biogas;
   iv) said cryogenic separation unit separating atmospheric gases into a liquid nitrogen, a liquid oxygen, and a third water;
   v) said liquid nitrogen fluidly coupled via a line 1 to said ammonia production plant;
   vi) at least one of said first, second and/or third water(s) fluidly coupled to said electrolyzer;
   vii) said electrolyzer producing a hydrogen gas (H₂) and an oxygen gas (O₂);
   viii) said O₂ from said electrolyzer fluidly coupled to said wastewater treatment plant;
   ix) a first portion of said H₂ from said electrolyzer plus said carbon dioxide from said biogas separation unit fluidly coupled to said e-fuel reactor for producing an e-fuel;
   x) said e-fuel reactor thermally coupled to said line 1 such that heat from said e-fuel reactor converts said liquid nitrogen to gaseous nitrogen;
   xi) a second portion of said H₂ fluidly coupled to said ammonia production plant for producing ammonia from said H₂ and said gaseous nitrogen from said line 1;
   xii) said ammonia production plant thermally coupled to said e-fuel reactor such that heat from said ammonia production plant drives said e-fuel reactor; and
   xiii) said e-fuel from said e-fuel reactor and/or said biogas separation unit fluidly coupled to a storage and/or distribution system.

Any system herein described, wherein said e-fuel is selected from a group consisting of e-methane, e-methanol, e-ethane, e-ethylene, and e-ethanol.

Any system herein described, wherein said e-fuel is e-methane.

Any system herein described, wherein said water splitting unit uses one or more of thermochemical, photoelectrochemical, electrical or photobiological energy to split water.

Any system herein described, wherein said water splitting unit or electrolyzer uses electricity from hydroelectric, solar, nuclear, wind power, wave power, geothermal, clean hydrogen or combinations thereof to split water.

Any system herein described, wherein said components a)-g) are in one location, preferably within 1 mile of each other.

Any system herein described, wherein said CO₂ for e-fuel synthesis is provided by one or more of said biogas separation unit, by direct air capture, biogenic carbon capture and storage (CCS), industrial CCS, or oxidation of carbon obtained as carbon black.

Any system herein described, wherein said biogas separation unit is selected from one or more of a single-pass membrane system, a multiple-pass membrane system, a cryogenic separator, a pressure swing adsorption (PSA), water scrubbing unit and a solvent scrubbing unit.

Any system herein described, wherein said biogas separation unit is a membrane system or a cryogenic separator.

Any system herein described, wherein said sludge is supplemented by biowaste from agriculture, paper production, timber production, household waste, food waste, sewage, or ethanol production.

Any system herein described, wherein said CO₂ for said e-methane reactor is supplemented by one or more of direct air capture, biogenic carbon capture and storage (CCS), industrial CCS, carbon black, or combinations thereof.

Any system herein described, wherein wastewater treatment plant and/or said anaerobic digestion unit further include one or more filtration unit(s).

Any system herein described, wherein said liquid nitrogen also provides chilling for cooling stages of said e-fuel reactor or said e-methane reactor.

As used herein, being at “one location” means being within a 10 mile radius, preferably within a 5 mile, or most preferred within a one mile radius.

As used herein, a “water treatment plant” is a unit that removes and eliminates contaminants from wastewater and converts this into an effluent that can be returned to the water cycle. Any water treatment technology may be used herein, but typically these units have included steps such as coagulation and flocculation, phase separation (such as sedimentation, clarification, filtration and the like), biological processes, such as biological degradation, and chemical processes (such as oxidation, ozonation, chlorination, aeration) or polishing. Oilfield wastewater is often processed through a three-phase centrifuge prior to processing of the oil, water, and gases. Other water sources may include wastewater from other industrial processes, sewage treatment, brines, and the like. The water may be further processed dependent upon the contaminants and the projected use.

The main by-product from a wastewater treatment plant, as used herein, is a type of sludge that is usually treated in the same or another wastewater treatment plant, plus of course, treated water, which may or may not yet be suitable for reuse, depending on the intended use. To the extent that any biogas is generated at this point, it may also be sent to the biogas separation unit, but the main producer of biogas is the anaerobic digestion unit.

As used herein an “anaerobic digestion unit” is a unit that uses anaerobes to break down biodegradable material in the absence of oxygen. The digestion process begins with bacterial hydrolysis of the input materials, such as sludge from the wastewater treatment plant. Insoluble organic polymers, such as carbohydrates, are broken down to soluble derivatives that become available for other bacteria. Acidogenic bacteria then convert the sugars and amino acids into carbon dioxide, hydrogen, ammonia, and organic acids. In acetogenesis, bacteria convert these resulting organic acids into acetic acid, along with additional ammonia, hydrogen, and carbon dioxide amongst other compounds. Finally, methanogens convert these products to methane and carbon dioxide—the primary components of biogas.

As used herein a “biogas separation unit” is any unit that separates the components of biogas into methane and carbon dioxide. Any separation methods known in the art may be used for the separation of biogas. Some available methods that may be employed include membrane systems-single-pass or multiple-pass, solvent scrubbing, water scrubbing, cryogenic separators, and pressure swing adsorption (PSA). The choice of the separator usually depends on space, available heat and/or cooling capacity, and infrastructure cost consideration for the operation. In one embodiment a cryogenic separator may use excess cooling from an LNG or cryogenic air separator (CASU) to separate CO₂ and CH₄ from the biogas.

Membrane systems for the separation of CO₂ and methane consist of a membrane filter with different sized pores, whereby the pores allow biogas to penetrate, and retain carbon dioxide. For application with restricted space requirement, a single-pass membrane system is generally used. Although efficient, a single-pass membrane system may not remove all impurities and gases from the biogas. For larger on-site spaces, multiple-pass membrane systems are used that use multiple passes through membranes for complete (up to 99%) separation of carbon dioxide and biogas.

Solvent scrubbing with chemicals such as an amine also separates carbon dioxide and methane. This is a very effective method of separation, and typically provides about 97-99% separation. Water scrubbing or water washing is also extensively used as it is relatively simple and cheaper method. Water wash of gases is conducted at higher pressures such that water dissolves carbon dioxide while the biogas passes through the system. The water containing carbon dioxide is depressurized releasing carbon dioxide. The efficiency of this method is very high with almost 99% of biogas completely separated from carbon dioxide. Water for this method may also be recycled in the integrated system described herein.

Any method known in the art can be used to generate the needed CO₂ for the e-fuel reactor herein. Thus, other carbon sources can supplement the CO₂ from the biogas separation unit. For example, direct air capture (DAC) or carbon capturing and storage (CSS) or conversion of carbon black, and the like may be used.

As used herein, “direct air capture” (DAC) is the process of extracting CO₂ from air by chemical and physical methods. Generally, CO₂ is captured by various methods, and when required, regenerated from the captured form. Examples include adsorbing CO₂ in a sorbent system (either solid or liquid), and storing CO₂ in the adsorbed form, and then regenerating. Aqueous monoethanolamine (MEA) is most commonly used liquid sorbent for CO₂. Other alkanolamines can also be used. Solid-based sorption can either be physisorption or chemisorption mechanisms. Physisorption is generally carried out by open-structure porous zeolite type materials, and chemisorption is generally using CaO, Ca(OH)₂, Na₂CO₃, NaHCO₃, etc. Lime-based capture of CO₂ is also common.

“Biogenic CCS” involves capturing and storing CO₂ from processes where biomass is converted into fuel. Thus, biogas synthesis is a way of making biogenic CCS, but any biological wastes may be used.

“Industrial CCS” is capturing CO₂ from industrial waste and emissions, for example from a power plant or any turbine generator or any flue gas.

As described herein, “electrolysis of water” is the process of splitting water into hydrogen and oxygen using electricity. This reaction takes place in a unit called the “electrolyzer”.

“Thermochemical water splitting” is the process of using very high temperatures, derived from solar power or from the waste heat of plants such as a nuclear power reaction or ammonia production plant, to produce hydrogen and water.

Another possible way of splitting water is using microorganisms, such as microalgae or cyanobacteria. This process is called “photobiological water splitting.” In “photoelectrochemical water splitting” methods, splitting of water is caused by sunlight and specialized semiconductors called photoelectrochemical materials which use light energy to directly dissociate water molecules.

Any of these methods of splitting water to make hydrogen may be used, but currently electrolysis is preferred.

As used herein, an “electrolyzer” is a unit that splits water into hydrogen and oxygen gases using energy from electricity. The electricity for electrolyzer is preferably a clean energy source, such as solar, wind, geothermal, wave, or nuclear-powered sources. Hydrogen gas can even be converted back into electricity by e.g., a hydrogen turbine or by reverse electrolyzation (commonly known as a ‘fuel cell’), e.g., during periods when wind and solar are not available. A methane turbine or mixed methane hydrogen turbine could also be used when the clean sources of energy are not available, and although not 100% green are still an improvement over fossil fuel use.

Water can also be split into hydrogen and oxygen using other energy sources, not just electricity. Thus, thermochemical water splitting units, photobiological water splitting units, photoelectrochemical water splitting units are considered herein as interchangeable with or equivalent to the electrolyzer unit. Adopting any of these energy sources would provide clean hydrogen. The location for such an integrated system can be sought so as to be near a sustainable source of power to efficiently produce electricity for the electrolyzer.

A “clean” hydrogen standard of 2 kg of CO₂ e/kg of H₂ is introduced by the Hydrogen and Fuel Cell Technologies Office. This standard is a way to apply a “clean” hydrogen definition that is technology independent.

“Electrofuels” also known as “e-fuels,” are synthetic fuels manufactured using captured carbon dioxide or carbon monoxide, together with hydrogen obtained from splitting water using sustainable energy sources. “E-fuels” include any fuels that can be synthesized from carbon dioxide. Typical e-fuels include e-methane, e-methanol, ethane, ethanol, propane, propanol, butane, butanol, diesel, or e-kerosene.

As used herein, an “e-fuel reactor” is a unit that converts CO₂ and hydrogen into one or more e-fuels.

E-methane, for example, can be synthesized by the reaction of carbon dioxide and hydrogen using Sabatier reaction. The carbon dioxide for the synthesis is obtained from biogas separation, the CASU unit, DAC, or carbon capture and storage (CCS) including biogenic CCS and industrial CCS, or oxidation of carbon as carbon black obtained from thermal decomposition of heavy petroleum products, or combinations of any of these. Hydromethanation and hydrogasification reactions can also be used for the synthesis of e-methane. Preferably, CO₂ produced by the integrated system herein is used as the predominant source of CO₂, but it may be supplemented as well.

The clean e-methane from the biogas separation and or e-fuel reactor may be sold as is or stored as liquified natural gas (LNG) in an LNG facility or sold directly to consumers. As noted, it may also be used to generate electricity.

As used herein the “cryogenic air separation unit” or “CASU” liquifies air and separates the main components thereof into liquid oxygen and liquid nitrogen by fractional distillation. A CASU may also be used to separate biogas into its components.

As used herein, the “ammonia production plant” is any unit that converts nitrogen and hydrogen to ammonia.

“Carbon sequestration” is the storage of carbon dioxide. Carbon can, for example, be stored underground in oil depleted reservoirs or in abandoned wells or stored in soil if biomass is allowed to contribute to soil. It can also be stored as biomass by the growth of plants or algae.

As used herein, “carbon neutrality” refers to a balance between emitting carbon and absorbing carbon from the atmosphere. A carbon neutral economy is achieved by avoiding emission activities, reducing carbon footprint, and removing and sequestrating carbon dioxide.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

TABLE 1
Abbreviations

| ABBREVIATION | TERM |
|---|---|
| CASU | Cryogenic air separation unit |
| CCS | Carbon capture and storage |
| CNG | Compressed natural gas |
| DAC | Direct air capture |
| GHG | Greenhouse gases |
| LNG | Liquified natural gas |
| MEA | Monoethanolamine |
| PSA | Pressure swing adsorption |

### BRIEF DESCRIPTION OF THE DRAWINGS

FIG. 1 shows an integrated system for the production of biogas, e-methane, hydrogen, ammonia and liquid oxygen.

FIG. 2A shows a production system of e-methane from DAC.

FIG. 2B shows a production system of e-methane from ethanol production from agricultural waste.

FIG. 2C shows a production system of e-methane from a CCS pipeline from power plants.

FIG. 2D shows a production system of e-methane using carbon black and an oxidizer.

FIG. 3 shows the steps of the exothermic heating/cooling process of methanation.

### DETAILED DESCRIPTION

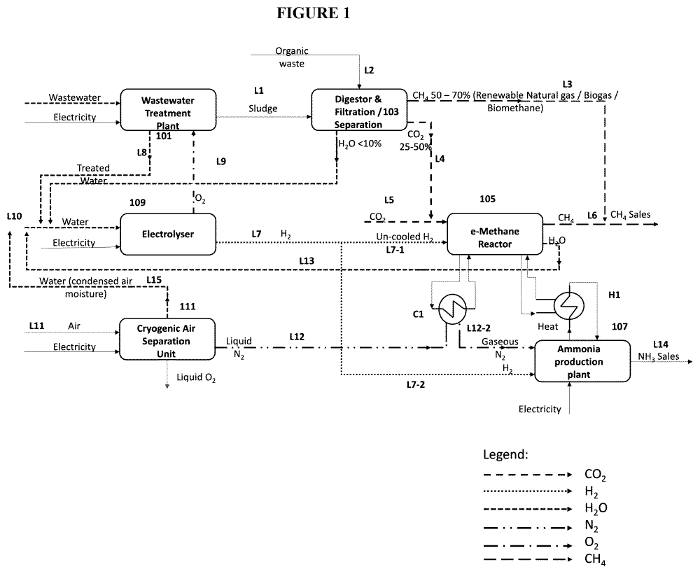

A schematic of the biogas-H₂-eCH₄—NH₃ integrated system is shown in FIG. 1. A wastewater treatment plant 101 treats water waste and sends organic slurry to an anaerobic digestor, filtration and separation unit 103 via L1. These digestor, filtration and separation units are combined herein, but of course may be separate. Organic waste from other plant and animal sources may also be directly fed into the digestor via L2.

Anaerobic digestion of organic waste produces biomethane, carbon dioxide and water, as well as sludge remnants. If desired the remnant sludge may be used as fertilizer, provided care is taken to monitor heavy metal levels. In 2021, about 56% of biosolids were used for land application and another 27% for landfills.

The biogases are separated at the separation unit, and renewable biomethane is sent off to sales or to combine with e-methane by line L3. CO₂ from the separation unit is collected and sent via L4 to e-methane reactor 105. CO₂ from other sources is also sent to the e-methane reactor 105 via L5, where together with H₂ from the electrolyzer, e-methane (or other e-fuel) is synthesized.

Treated water from the wastewater treatment plant is sent to an electrolyzer 109, powered by renewable source of energy by connecting line L8. Electrolysis of water takes place in the electrolyzer converting water into gaseous H₂ and O₂. Water from various sources including wastewater treatment plant (via L8), e-methane reactor (via L13), condensed water vapors from air (via L15) and stored water from other sources (via L10) may all be used as input for the electrolyzer.

O₂ gas produced by the electrolyzer is sent to wastewater treatment plant via L9, where the oxygen stimulates bacterial growth. It could be sent to the digester, but most frequently the digester units are anaerobic and oxygen would be detrimental. Thus, it could only be used in aerobic portions of the digestor, if any. Alternatively, oxygen may be sent to the cryogenic unit (not shown) for liquefaction and storage or sale.

H₂ gas produced by the electrolyzer is the key starting material for the synthesis of e-methane that takes place in e-methane reactor 105 as well as for the production of ammonia at the ammonia production plant 107. H₂ is thus sent to the respective CH₄ and NH₃ reactors via L7 and enters the e-methane reactor via L7-1 and the ammonia production plant by L7-2.

E-methane is produced from the CO₂ from biogas separation or another source, plus H₂ from the electrolyzer at e-methane reactor 105. The methane (or other e-fuel) is sent for storage, and distribution and sales via L6, or as noted may also be used for energy production. E-methane from the combined digester, filtration and biogas separation unit is also connected via L3 and combined with e-methane from L6 and sent to sales or storage. Production of methane also produces water as a by-product, which may be sent back to the electrolyzer via L13.

The nitrogen gas for the ammonia production plant 107 is obtained by a cryogenic air separation unit (CASU) 111 where atmospheric gases are sent to the unit by L11 and are separated by cooling and liquifying them and then selectively distilling out each component. Liquid N₂ is transferred via L12 to a heat exchanger C1 where heat from e-methane synthesis (and/or the ammonia production plant) vaporizes liquid nitrogen (thus chilling that methane stage) to gaseous N₂ which enters the ammonia production plant 107 via L12-2. Liquid oxygen is also obtained at the CASU 111 and may be stored in cylinders for further use or routed to wastewater treatment (not shown). Condensed water separated out at the CASU may be sent back to the electrolyzer 109 via L15.

The reaction of N₂ and H₂ to produce ammonia at the ammonia production plant is highly exothermic. The heat produced by the ammonia production plant can thus be used for the e-methane reactor by using heat exchanger H1. This removal of heat from the ammonia reactor will also propel the reaction to form ammonia to completion. Ammonia is safely recovered from the production plant and sent for storage and/or sales via L14.

This integrated system presents an environmentally sustainable system where gases, water and energy released from one reaction are integrated into the next reaction and presents a beneficial loop of multiple commercially useful synthesis as well as a way to use carbon dioxide emitted from human activities and synthesis of biogas, etc.

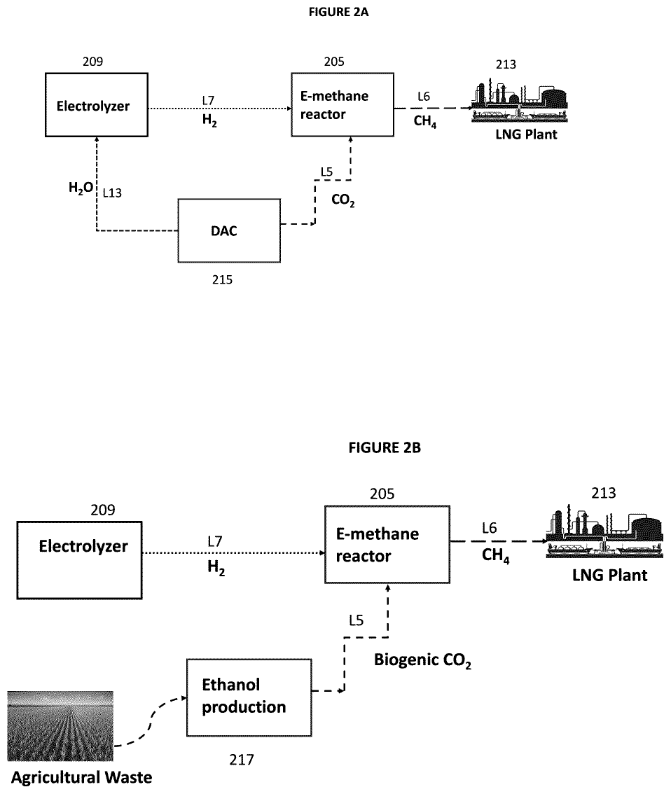

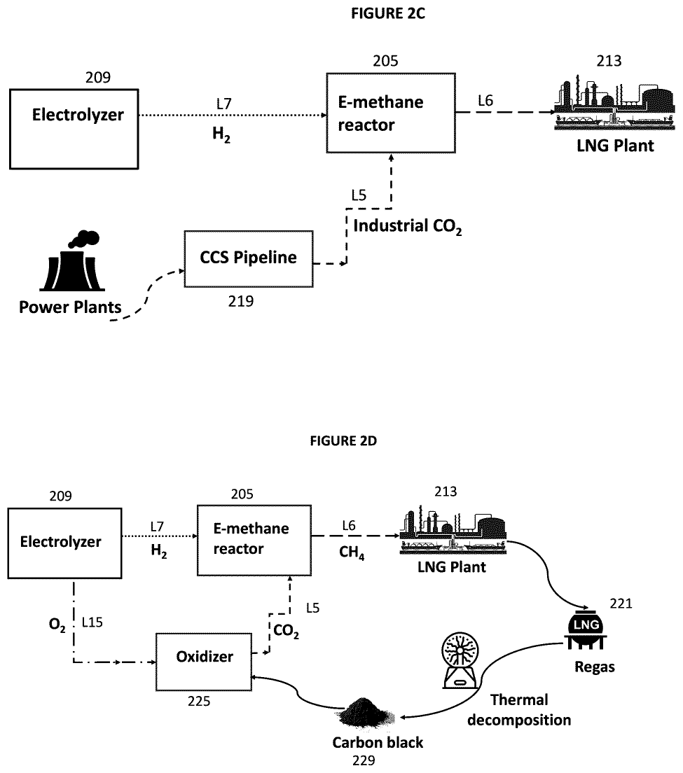

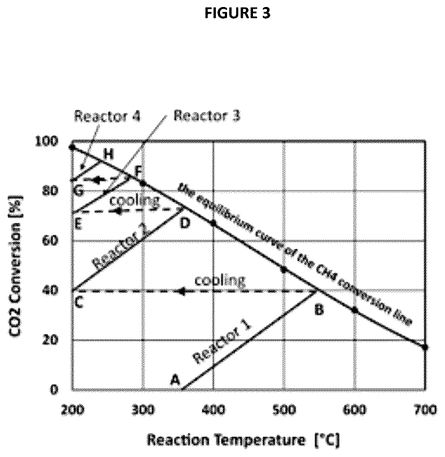

FIG. 2A-D focus on the electrolyzer and e-methane synthesis unit of FIG. 1 to highlight the sources of carbon dioxide for the e-methane production, and the fate of e-methane produced. The ecosystem described herein may use any one or more of these CO₂ sources.

FIG. 2A shows carbon dioxide obtained from direct air capture (DAC) 215. E-methane produced in the e-methane reactor 205 is sent via L6 to a CNG or LNG plant 213 and distributed. Electrolyzer 209 feeds hydrogen gas to the e-methane reactor 205 via L7, and water from DAC is circulated back into the electrolyzer 209 via L13.

FIG. 2B shows an example of using biogenic carbon dioxide derived from ethanol production 217 in agricultural waste. Any biowaste may be used in this figure.

FIG. 2C provides an example of carbon dioxide obtained from carbon capture and storage (CCS) 219 from burning of fuel from a power plant or any turbine generator or combustor.

FIG. 2D shows carbon dioxide obtained from oxidation of carbon black in an oxidizer 225 with gaseous oxygen from the electrolyzer fed into the oxidizer via line L15. This figure also shows the regassification of LNG in a regas facility 221 where thermal decomposition converts the gas into carbon black 229. The carbon black may be transported in from long distances as it is easily packaged and shipped.

The examples presented herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety for all purposes:
U.S. Pat. No. 8,940,265 “Sustainable economic development through integrated production of renewable energy, materials resources, and nutrient regimes.”
US20130255140 “Method to reduce GHG emissions of fuel production.”
Brannstrom, C., et al “The emerging energy future(s) of renewable power and electrochemistry.” Energy Democracies for Sustainable Futures, 2023, p 99-106.
Ali, A., et al “Carbon neutrality concept and progress.” Recent Developments in Green Finance, Green Growth and Carbon Neutrality, 2023, p 85-108.
Styring, P. et al “Carbon dioxide utilization.” Negative emissions. Technology for climate change mitigation, 2023, p. 391-413.
Periyasamy, S., et al “Wastewater to biogas recovery.” Clean Energy and Resources Recovery, 2022, p 301-214.
Synthetic methane could smooth the path to net zero. Nature Portfolio, available online at nature.com/articles/d42473-022-00166-2.
Sodiq, A., et al. “A review on progress made in direct air capture of CO₂” Environmental Technology & Innovation, Vol. 29, 102991.

1. An integrated system for producing e-fuel and ammonia, said system comprising components a)-g) as follows:
a) a wastewater treatment plant;
b) an anaerobic digestion unit;
c) a biogas separation unit;
d) a water splitting unit;
e) an e-fuel reactor;
f) a cryogenic separation unit; and
g) an ammonia production plant;
wherein said components a)-g) are interconnected as follows:
i) said wastewater treatment plant producing a first water and a sludge;
ii) said sludge fluidly coupled to said anaerobic digestion unit for producing a biogas and a second water;
iii) said biogas fluidly coupled to said biogas separation unit for producing an e-fuel and carbon dioxide;
iv) said cryogenic separation unit separating atmospheric gases into a liquid nitrogen, a liquid oxygen, and a third water;
v) said liquid nitrogen fluidly coupled via a line 1 to said ammonia production plant;
vi) at least one of said first, second and/or third water(s) fluidly coupled to said water splitting unit;
vii) said water splitting unit producing a hydrogen gas (H₂) and an oxygen gas (O₂);
viii) said O₂ from said water splitting unit fluidly coupled to said wastewater treatment plant;
ix) a first portion of said H₂ from said water splitting unit fluidly coupled to said e-fuel reactor plus carbon dioxide (CO₂) from said biogas separation unit fluidly coupled to said e-fuel reactor, said e-fuel reactor producing an e-fuel from said hydrogen gas and said carbon dioxide;
x) said e-fuel reactor thermally coupled to said line 1 such that heat from said e-fuel reactor converts said liquid nitrogen to gaseous nitrogen;
xi) a second portion of said H₂ fluidly coupled to said ammonia production plant for producing ammonia from said H₂ and said gaseous nitrogen from said line 1;
xii) said ammonia production plant thermally coupled to said e-fuel reactor such that heat from said ammonia production plant drives said e-fuel reactor; and
xiii) said e-fuel from said e-fuel reactor and/or said biogas separation unit fluidly coupled to a storage and/or distribution system.

2. The system of claim 1, wherein said e-fuel is selected from a group consisting of e-methane, e-methanol, e-ethane, e-ethylene, and e-ethanol.

3. The system of claim 1, wherein said e-fuel is e-methane.

4. The system of claim 1, wherein said water splitting unit uses one or more of thermochemical, photoelectrochemical, electrical or photobiological energy to split water.

5. The system of claim 1, wherein said water splitting unit or electrolyzer uses electricity from hydroelectric, solar, nuclear, wind power, wave power, geothermal, clean hydrogen or combinations thereof to split water.

6. The system of claim 1, wherein said components a)-g) are in one location.

7. The system of claim 1, wherein said CO₂ for e-fuel synthesis is provided by one or more of said biogas separation unit, by direct air capture, biogenic carbon capture and storage (CCS), industrial CCS, or oxidation of carbon obtained as carbon black.

8. The system of claim 1, wherein said biogas separation unit is selected from one or more of a single-pass membrane system, a multiple-pass membrane system, a cryogenic separator, a pressure swing adsorption (PSA), water scrubbing unit and a solvent scrubbing unit.

9. The system of claim 1, wherein said biogas separation unit is a membrane system or a cryogenic separator.

10. The system of claim 1, wherein said sludge is supplemented by biowaste from agriculture, paper production, timber production, household waste, food waste, sewage, or ethanol production.

11. The system of claim 1, wherein said CO₂ for said e-fuel reactor is supplemented by one or more of direct air capture, biogenic carbon capture and storage (CCS), industrial CCS, carbon black, or combinations thereof.

12. The system of one of claim 1, wherein said wastewater treatment plant and/or said anaerobic digestion unit further include one or more filtration unit(s).

13. The system of claim 1, wherein said liquid nitrogen provides chilling for cooling stages of said e-fuel reactor or said e-methane reactor.

14. An integrated system for producing e-methane and ammonia, said system comprising components a)-g) as follows:
a) a wastewater treatment plant;
b) an anaerobic digestion unit;
c) a biogas separation unit;
d) an electrolyzer;
e) an e-methane reactor;
f) a cryogenic separation unit; and
g) an ammonia production plant;
wherein said components a)-g) are interconnected as follows:
i) said wastewater treatment plant producing a first water and a sludge;
ii) said sludge fluidly coupled to said anaerobic digestion unit for producing a biogas and a second water;
iii) said biogas fluidly coupled to said biogas separation unit for separating methane and carbon dioxide from said biogas;
iv) said cryogenic separation unit separating atmospheric gases into liquid nitrogen, a liquid oxygen, and a third water;
v) said liquid nitrogen fluidly coupled via a line 1 to said ammonia production plant;
vi) at least one of said first, second and/or third water(s) are fluidly coupled to said electrolyzer;
vii) said electrolyzer producing a hydrogen gas (H₂) and an oxygen gas (O₂);
viii) said O₂ from said electrolyzer fluidly coupled to said wastewater treatment plant;
ix) a first portion of said H₂ from said electrolyzer plus said carbon dioxide from said biogas separation unit fluidly coupled to said e-methane reactor for producing methane;
x) said e-methane reactor thermally coupled to said line 1 such that heat from said e-methane reactor converts said liquid nitrogen to gaseous nitrogen and removes heat from one or more streams;
xi) a second portion of said H₂ fluidly coupled to said ammonia production plant for producing ammonia from said H₂ and said gaseous nitrogen from line 1;
xii) said ammonia production plant thermally coupled to said e-methane reactor such that heat from said ammonia production plant drives said e-methane reactor; and
xiii) said methane from said e-methane reactor and/or said biogas separation unit fluidly coupled to a storage and/or distribution system.

15. The system of claim 14, wherein said CO₂ for e-methane synthesis is provided by one or more of said biogas separation unit, by direct air capture, biogenic carbon capture and storage (CCS), industrial CCS, or oxidation of carbon obtained as carbon black.

16. The system of claim 14, wherein said biogas separation unit is selected from one or more of a single-pass membrane system, a multiple-pass membrane system, a cryogenic separator, a pressure swing adsorption (PSA), water scrubbing unit and a solvent scrubbing unit.

17. The system of claim 14, wherein said sludge is supplemented by biowaste from agriculture, paper production, timber production, household waste, food waste, sewage, or ethanol production.

18. The system of claim 14, wherein said CO₂ for said e-methane reactor is supplemented by one or more of direct air capture, biogenic carbon capture and storage (CCS), industrial CCS, carbon black, or combinations thereof.

19. The system of one of claim 14, wherein said wastewater treatment plant and/or said anaerobic digestion unit further include one or more filtration unit(s).

20. The system of claim 14, wherein said liquid nitrogen provides chilling for cooling stages of said e-fuel reactor or said e-methane reactor.
